(19) United States
(12) Patent Application Publication
(10) Pub. No.: US 2024/0209754 A1
(43) Pub. Date: Jun. 27, 2024

(54) METHOD FOR OPERATING A FLIGHT-PROPULSION SYSTEM

(71) Applicant: MTU Aero Engines AG, München (DE)

(72) Inventors: Stephan Bock, Olching (DE); Hermann Klingels, Dachau (DE); Oliver Schmitz, München (DE)

(73) Assignee: MTU Aero Engines AG, München (DE)

(21) Appl. No.: 18/555,828

(22) PCT Filed: Apr. 12, 2022
(86) PCT No.: PCT/DE2022/100280

§ 371 Date: Oct. 17, 2023

(30) Foreign Application Priority Data
Apr. 19, 2021 (DE) 10 2021 109 848.3

(51) Int. Cl. F01D 25/32

(52) U.S. Cl. CPC F01D 25/32; F05D 2220/323; F05D 2260/608

(57) ABSTRACT

The present invention is directed to a method for operating a flight-propulsion system of an aircraft, the flight-propulsion system having a propulsion unit, a water discharger arranged downstream of the propulsion unit and a reservoir for receiving water, in which method the propulsion unit is operated and, during a flight of the aircraft, water resulting from the operation of the propulsion unit is discharged by the water discharger, wherein at least some of the discharged water is fed to the reservoir, and wherein at least some of the water that is fed to the reservoir is given off to the surroundings while the flight is still in progress, that is to say is only temporarily stored in the reservoir.

### BACKGROUND OF THE INVENTION

### Technical Field

The present invention relates to a method for operating a flight-propulsion system.

### Prior Art

The propulsion unit of such a flight-propulsion system can be, for example, an axial turbomachine, which is divided functionally into compressor, combustion chamber, and turbine. In the compressor, air intake is compressed and subsequently admixed with fuel, such as, for example, kerosene, and this mixture undergoes combustion in the combustion chamber. The resulting hot gas or combustion gas flows through the turbine and undergoes expansion therein, with energy being taken from the gas proportionately to drive the compressor. A propeller or, in particular, a fan, which is also driven by the turbine, can be provided, for example, to generate propulsion. Such an engine with a fan is also referred to as a turbofan engine.

In addition to the propulsion unit, the propulsion system at issue has a water discharger, by which, in the case of the axial turbomachine, for example, water can be separated from the exhaust gas thereof.

### SUMMARY OF THE INVENTION

The present invention is based on the technical problem of specifying an advantageous method for operating a flight-propulsion system as well as an advantageous flight-propulsion system for an aircraft.

This problem is solved in accordance with the method and by the propulsion system according to the present invention. In addition to the propulsion unit and the water discharger, the propulsion system has a reservoir for receiving water. During flight of the aircraft, water, which, for example, results from the exhaust gas or, in general, from the operation of the propulsion unit, is discharged by the water discharger. In this case, in order to prevent or reduce a contrail or cloud formation, at least a portion of this water is not given off to the surroundings, but rather fed to the reservoir. On the other hand, however, the water in the reservoir is not stored over the entire duration of the flight, which could be disadvantageous because of the increasing weight. Instead, it is given off to the surroundings while the flight is in progress, when, for example, the atmospheric conditions with respect to cloud formation are uncritical or less critical.

Preferred embodiments are found in the dependent claims and in the entire disclosure, whereby, in the description of features, a distinction in detail is not always made between device aspects and method aspects or use aspects; in any case, the disclosure is to be read implicitly in terms of all claim categories. If, for example, a flight-propulsion system that is suitable for a certain method is described, then it is to be understood at the same time as being a disclosure of a corresponding operating method and vice versa. Likewise, the aspects relating to the flight-propulsion system are also to be understood always as also relating to an aircraft having such a flight-propulsion system.

If the aircraft, such as, for example, a passenger aircraft, finds itself temporarily in an atmospheric layer that is critical with respect to cloud formation, no water or at least less water should be given off to the surroundings, for which reason it is stored temporarily in the reservoir. A cloud formation or contrail formation that otherwise results is also under discussion, for example, as a parameter affecting climate change and is not desired. If the aircraft later finds itself in a less critical atmospheric layer, the water can be discharged from the reservoir to the surroundings. In this way, the weight is reduced and, accordingly, the thrust required for the propulsion of the aircraft is reduced.

The water discharged by the water discharger results, quite generally, “from the operation of the propulsion unit” and therefore, in any case, results directly from the utilization thereof to generate thrust. As explained in the introduction, in the case of a combustion engine, in particular an axial turbomachine, the water is discharged from the exhaust gas thereof, that is, it is separated from it. In the case of a hydrogen-powered aircraft, water can also result from the combustion; it can result in a propulsion unit having fuel cells, but it can also ensue from an electric power conversion of the hydrogen, whereby the actual generation of thrust then occurs, for example, via an electric motor. Regardless of whether the hydrogen is utilized directly or indirectly, it is possible in accordance with the present subject to store temporarily at least a portion of the resulting water and to give it off only later, albeit still while the flight is in progress. Regardless of the origin of the water, it is possible in accordance with the invention to at least prevent a contrail formation or cloud formation, which can otherwise ensue in the case of exhaust gas, for example, as a consequence of a condensation in the cold surrounding air.

In accordance with a preferred embodiment, at least a portion of the water given off to the surroundings is discharged from the reservoir directly to the surroundings. “Directly” means, for example that the water is left in the same state of aggregation, that is, experiences no change in state prior to the discharge. In general, the water is stored preferably in liquid form in the reservoir, with it then being given off at least proportionately also in liquid form in the present variant. In the case of a discharge under unfavorable atmospheric conditions (which is avoided by the temporary storage), the liquid water could also be critical in regard to a cloud formation because, for example, at a relatively high flight speed, the droplets can be “ripped apart,” so that “microdroplets” result.

In one preferred embodiment, at least a portion of the water given off to the surroundings from the reservoir is brought beforehand into gas form and fed into a gas channel of the propulsion unit. In other words, the water is given off to the surroundings not directly in liquid form, but rather indirectly via the gas channel of the propulsion unit, which is then designed as a heat engine, in particular the gas channel of an axial turbomachine. To this end, the water is initially vaporized, with it being possible to take the energy required for this from the exhaust gas by using, for instance, a vaporizer through which exhaust gas flows. In this way, it is already possible to achieve a certain cooling of the exhaust gas, which, for example, can be advantageous with respect to the condensation in the water discharger.

Regardless of this, water vapor that is introduced into the gas channel can be of advantage, for example, because of the required compressor work; namely, less work is required in comparison to the same amount of air without water vapor. In the combustion chamber, the water vapor can also reduce, for example, nitrogen oxides in the exhaust gas, because the water with its relatively high heat capacity can prevent the creation of temperature spikes in the case of locally nonuniform mixing conditions. Alternatively or additionally, the water vapor can also be utilized for component cooling, such as, for example, cooling of channel walls, in particular gas-channel walls or, in particular, blades or vanes. To this end, for example, it can flow through a channel system in the interior of the component, in particular of a blade or vane.

In accordance with a preferred embodiment, the temporary storage of water occurs depending on the atmospheric conditions recorded during the flight. The atmospheric conditions can be recorded continuously, for example, or at least in intervals. In the course of an evaluation of this data, it is then possible, for example, to bring about an optimization in that, on the one hand, the quantity of water that is stored temporarily in the reservoir is kept as small as possible for reasons of weight, whereby, on the other hand, insofar as possible, a discharge of water under critical atmospheric conditions is avoided, however. In general, however, such a dynamic evaluation is not obligatory, but rather the water can be stored temporarily and given off, for example, also on the basis of standardized atmospheric data (for example, depending on altitude, etc.).

In accordance with a preferred enhancement, on-board sensors of the aircraft can be used in order to record diverse environmental parameters, such as, for example, a flight altitude, a relative air humidity, an external pressure, an external temperature, etc. On the basis of these parameters, it is possible to check various criteria in regard to the formation and/or the persistence of contrails. In accordance with one embodiment, these parameters can be used to check whether the Schmidt-Appleman criterion is fulfilled and to deduce from this the formation and/or the persistence of contrails.

In accordance with a further exemplary embodiment, it can be checked whether the external temperature lies below 245° K, in particular below 237° K, and, in the case when this value is not attained, the water is stored. In a further exemplary embodiment, it is possible on the basis of the external temperature and the external pressure to check whether a water saturation vapor pressure is exceeded and, on the basis of this criterion, to decide whether the water is stored. In accordance with a further exemplary embodiment, it is possible for the water to be stored at a relative air humidity of at least 0.8 starting at a flight altitude of 9 km and/or at a relative air humidity of at least 0.6 starting at a flight altitude of 9.4 km and/or at a relative air humidity of at least 0.2 starting at a flight altitude of at least 9.7 km and/or at a relative air humidity of 0 starting at a flight altitude of at least 10 km.

In accordance with one preferred embodiment, the aircraft is caused to change altitude when water is temporarily stored in the reservoir or when, during the temporary storage, a certain filling level has been exceeded. It can transpire, for example, that the atmospheric conditions at a certain flight altitude favor the cloud formation, but are not critical at another flight altitude. The temporary storage of the water can bridge the time until this non-critical flight altitude is reached. The “causing” of a change in altitude can be produced, for example, via a signal generator, such as, for instance, via a display unit as information for the pilots or else internally as an input signal for a partially or also fully autonomous flight control.

In accordance with a preferred embodiment, the temporarily stored water is caused to be given off to the surroundings after a change in altitude of the aircraft. This can be, in general, also a change in altitude that would ensue anyway; preferably, however, this change in altitude would be caused beforehand by a corresponding signal (see above).

As discussed in the introduction, the propulsion system according to the invention has, in addition to the propulsion unit and the water discharger, the reservoir, in which, during operation, the water can be stored temporarily. The reservoir is thereby equipped with a controllable outlet, which is actuated by a control unit. The controllable outlet can have one controllable valve or a plurality of controllable valves. It is possible via the outlet to feed the temporarily stored water to the surroundings directly in liquid form and/or indirectly by way of recirculation (in vapor form via the gas channel). The control unit, which, for example, can be provided as a separate element (for example, a microcontroller or an ASIC) or can be integrated in the onboard computer, is set up to cause the propulsion system to carry out the methods disclosed above.

Through appropriate actuation of the outlet, the water that is discharged can be stored temporarily in the reservoir (outlet closed) or given off to the surroundings (outlet opened). In addition, for example, the reservoir can also be equipped with a controllable inlet, via which the water that is discharged enters the reservoir when it is to be stored temporarily or else, alternatively, can be fed past the reservoir (optional bypass when no temporary storage is required). Regardless of these details, the control unit also can be, for example, a part of a control loop, whereby, for example, the filled level of the reservoir can be entered as a control parameter.

In accordance with a preferred embodiment, the flight-propulsion system has a sensor system for measuring an air parameter, namely, a temperature, a pressure, and/or a water load of the air. The temperature can be recorded statically and/or as a total temperature, likewise, a static and/or dynamic pressure can be measured. The evaluation of the recorded data can be produced by a separate evaluation unit, but, on the other hand, it can also be integrated functionally in the control unit. If the recorded air parameter is critical in terms of a cloud formation (for example, high water load, low pressure, etc.), that is, if the ice saturation has been reached, for example, the control unit can bring about the temporary storage, optionally in conjunction with causing a change in altitude.

In accordance with one preferred embodiment, the flight-propulsion system has a sensor system for optical recording of clouds. This sensor system can be, for example, a camera that is directed backwards in order to identify condensation behind the aircraft. The optical recording of clouds makes possible an analysis of the actual state in order to monitor, for instance, the air parameter-based control or else to be used as an alternative to it. The information thereby obtained can serve, in any case, as input for the control unit.

One preferred embodiment relates to the already discussed “causing of a change in altitude,” for which purpose the propulsion system has a signal generator. If, for example, on account of critical atmospheric conditions, water is stored temporarily in the reservoir, that is, the water level rises or exceeds a certain threshold, it is possible via the signal generator to initialize a change in the flight altitude. As described above, this can proceed via an external interface or, in the case of an integration in the onboard computer, also as an internal computing operation.

In accordance with one preferred embodiment, the reservoir has a volume of such a size that in it, over at least 2 minutes, preferably at least 5 minutes, the discharged water is received and can be stored temporarily. This can relate, for example, to the quantity of water that is discharged from the temporary propulsion unit under cruise condition. The volume is also preferably determined in such way that critical atmospheric layers are “bridged” by temporary storage, that is, are traversed in flight and/or can be circumvented by an adjustment in altitude. Obtaining the requisite flight safety clearance for this can take several minutes, for example, and critical layers can also be relatively thin sometimes, having a thickness of a few hundred meters, for example, Possible upper limits of the volume or of the storage duration for which the reservoir is designed can lie, for example, at an hour, a half hour, or also only a quarter hour.

In absolute values, the reservoir can have, for example, a volume of at least 200 L, further and especially preferred at least 300 L or 500 L. Possible upper limits, which are to be disclosed independently of the lower limits, can lie, for example, at maximally 6000 L, 3000 L, or 1500 L. Also independent of the absolute value in particular, an advantage of the at least proportionate discharge of water during the flight can lie in the limitation of the requisite reservoir size; that is, the tank is also markedly more compact and lighter in itself in comparison to storage over the entire duration of the flight.

As already mentioned, in accordance with a preferred embodiment, the propulsion unit is a heat engine, in particular an axial turbomachine, and the water discharger is a water separator that discharges the water from the exhaust gas thereof. To this end, furthermore, it is possible to provide an exhaust-gas treatment device, in the exhaust-gas channel of which the exhaust gas containing water vapor is cooled. It is possible by the cooling to achieve at least a partial condensation of the water contained in the exhaust gas, said water, together with additional products (CO₂, etc.), resulting from the combustion of fossil fuels or else having been introduced deliberately beforehand in vapor form into the combustion chamber. Furthermore, the exhaust-gas treatment device can have a droplet separator, which can separate off water that, owing to cooling, has condensed in the exhaust-gas channel, on the basis of centrifugal force or inertial force, for example, such as, for instance, a cyclone or spin separator, or else such separation can be produced by way of sharp deflection, etc. In detail, the heat engine can be, in particular, a turbofan engine, but, in general, for example, also a turbojet or turboprop engine.

In accordance with one preferred embodiment, the flight-propulsion system is employed in an aircraft that can be manned or, in general, also unmanned.

The invention further relates to the use of a flight-propulsion system in a way described above

### BRIEF DESCRIPTION OF THE DRAWING FIGURES

The invention is described in detail below on the basis of an exemplary embodiment, whereby, in the scope of the dependent claims, the individual features can also be of essence to the invention in a different combination and, furthermore, no distinction is made in detail between the different claim categories.

Shown in detail:

FIG. 1 is a flight-propulsion system according to the invention in schematic illustration;

FIG. 2 is an aircraft in schematic illustration.

### DESCRIPTION OF THE INVENTION

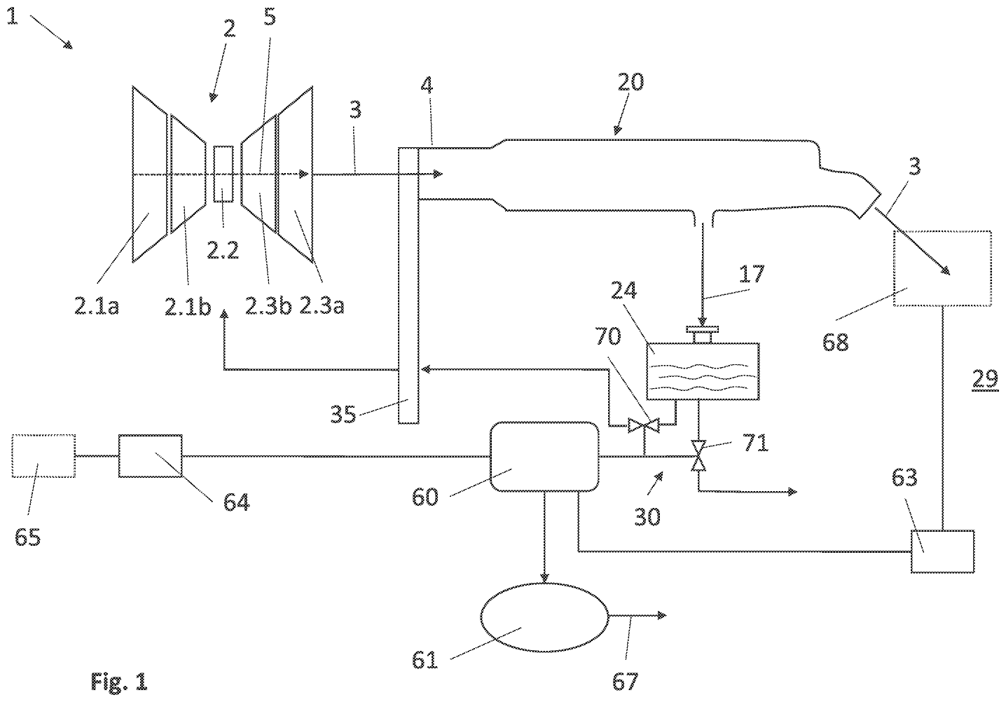

FIG. 1 shows a flight-propulsion system 1 according to the invention, which has a propulsion unit 2, a water discharger 20 arranged downstream of the propulsion unit 2, and a reservoir 24. The propulsion unit 2 can be seen as a schematically indicated aircraft engine; in this example, it has a low-pressure compressor 2.1a with a fan, a high-pressure compressor 2.1b, a combustion chamber 2.2, a high-pressure turbine 2.3b, and a low-pressure turbine 2.3a. Involved here is a so-called turbofan engine. During operation, an exhaust gas 3 from the low-pressure turbine 2.3a enters an exhaust-gas channel 4 of the water discharger 20, which, in the present case, is designed as a water separator.

There, the water 17 contained in the exhaust gas 3 is condensed at least proportionately and discharged. Without this condensation, the water contained in the exhaust gas 3 could lead to contrails (cirrus clouds), for example, depending on the atmospheric conditions. This cloud formation, which, for example, is disadvantageous in terms of the greenhouse effect, can be prevented by the condensation. However, if the condensed water 17 were stored over the entire duration of the flight, this would result in a substantial increase in weight, which, for example, would be disadvantageous in terms of fuel consumption. For this reason, in accordance with the invention, a reservoir 24 is provided, although the water discharged into it is only stored temporarily.

The reservoir 24 is equipped with a controllable outlet 30, which comprises a first controllable valve and a second controllable valve 70, 71. Via the controllable outlet 30, the temporarily stored water can be given off during the flight, that is, when still in the air, to the surroundings 29 when atmospheric conditions are less critical with respect to a cloud formation. In this case, the temporarily stored water can be given off to the surroundings 29 either directly, that is, in liquid form, via the controllable valve 71 or it can be recirculated via the controllable valve 70. In this case, it is fed to a vaporizer 35, brought there into vapor form, and then fed again to the engine 2, that is, to the gas channel 5 thereof, preferably to the combustion chamber 2.2 (compare the introductory description in detail).

Further illustrated schematically are a sensor system 64 for measuring an air parameter 65, a sensor system 63 for optical recording of clouds 68, and a control unit 60. The air parameter 65 can comprise, for example, a temperature, a pressure, and a water load of the air and it is possible from them to determine the atmospheric conditions. The sensor system 63 for optical recording of clouds 68 can comprise a camera, by which the cloud formation behind the aircraft can be determined.

By the control unit 60, the valves 70, 71 are actuated on the basis of the air parameter 65 of the sensor system 64 and the optical recording of the sensor system 63. Because the outlet 30 comprises two valves 70, 71, it is possible to control both the quantity of water given off directly to the surroundings and also the quantity of water fed into the gas channel 5. Furthermore, the control unit 60 can emit a signal 67 via a signal generator 61, said signal bringing about a change in altitude when the reservoir 24 is full in an atmospheric layer that is critical with respect to cloud formation.

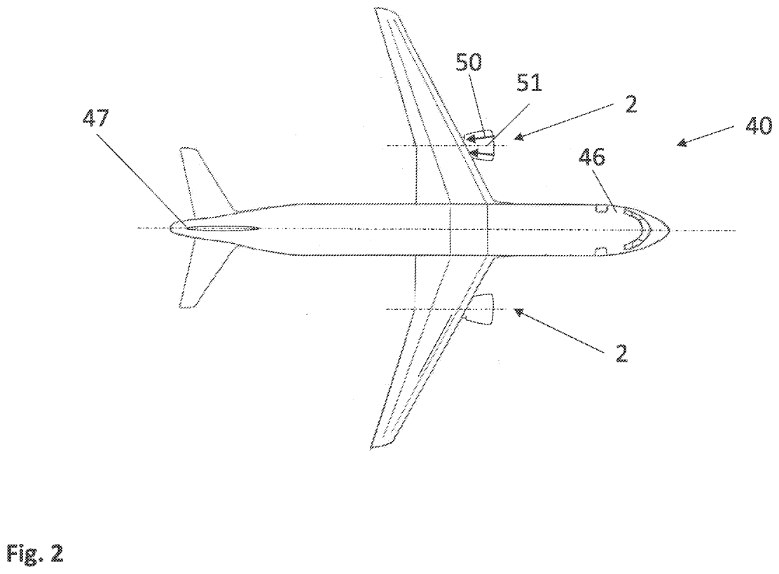

FIG. 2 shows in schematic illustration an aircraft 40 having two propulsion units 2. The sensor system 63 for optical recording of the clouds 68 can be arranged, for example, in a tail part 47 of the fuselage 46. The sensor system 64 for measuring the air parameter 65 can be arranged, for example, on the fuselage 46 or else on the propulsion unit 2 in, for instance, the inlet in front of the fan 2.1a, in the secondary flow channel 50, or on the engine nacelle 51.

1. A method for operating a flight-propulsion system of an aircraft, said flight-propulsion system having
a propulsion unit,
a water discharger arranged downstream of the propulsion unit, and
a reservoir for receiving water,
wherein
the propulsion unit is operated and, during a flight of the aircraft, water which results from the operation of the propulsion unit, is discharged by the water discharger,
wherein at least a portion of the discharged water is fed to the reservoir and wherein at least a portion of the water that is fed to the reservoir is given off to the surroundings while the flight is in progress and is only stored temporarily in the reservoir.

2. The method according to claim 1, wherein at least a portion of the water that is given off to the surroundings is discharged from the reservoir directly in liquid form to the surroundings.

3. The method according to claim 1, wherein at least a portion of the water that is given off to the surroundings is brought into gas form and is fed to a gas channel of the propulsion unit.

4. The method according to claim 1, wherein the temporary storage of the water takes place depending on atmospheric conditions recorded during the flight.

5. The method according to claim 1, wherein, when at least the portion of the discharged water is fed to the reservoir and is stored temporarily, the aircraft is caused to change altitude.

6. The method according to claim 1, wherein the discharge of the temporarily stored water to the surroundings takes place after a change in altitude of the aircraft.

7. A flight-propulsion system for an aircraft, having
a propulsion unit,
a water discharger arranged downstream of the propulsion unit for discharging water resulting from an operation of the propulsion unit,
a reservoir for receiving at least a portion of the water discharged by the water discharger,
a controllable outlet, via which at least a portion of the water fed to the reservoir can be given off to the surroundings, and
a control unit for actuating the outlet,
wherein the control unit is configured and arranged to cause the flight-propulsion system to carry out a method according to claim 1.

8. The flight-propulsion system according to claim 7 having a sensor system for measuring an air parameter, said air parameter comprising at least one of the following: a temperature, a pressure, and a water load of the air.

9. The flight-propulsion system according to claim 7 having a sensor system for optical recording of clouds.

10. The flight-propulsion system according to claim 7 having a signal generator, wherein the control unit is set up to emit a signal via the signal generator, said signal causing the aircraft to change altitude when at least the portion of the discharged water is fed to the reservoir and stored temporarily.

11. The flight-propulsion system according to claim 7, wherein the reservoir has a volume of such size that, for at least two minutes, the water discharged by the water discharger is received and stored temporarily.

12. The flight-propulsion system according to claim 7, wherein the reservoir has a volume of at least 200 liters and a maximum of 2000 liters.

13. The flight-propulsion system according to claim 7, wherein the propulsion unit is a heat engine and the water discharger is a water separator that discharges the water from an exhaust gas of the heat engine.

14. An aircraft with a flight-propulsion system according to claim 7.

15. Use of a flight-propulsion system, which has
a propulsion unit,
a water discharger arranged downstream of the propulsion unit for discharging water resulting from an operation of the propulsion unit, and
a reservoir for receiving at least a portion of the water discharged by the water discharger,
in a method according to claim 1.
